(19) United States
(12) Patent Application Publication
(10) Pub. No.: US 2011/0199861 A1
(43) Pub. Date: Aug. 18, 2011

(54) METHOD AND SYSTEM FOR DETECTING MOTORIZED OBJECTS

(75) Inventor: Dror Lapidot, Ganei Hadar (IL)

(73) Assignee: ELTA SYSTEMS LTD., ASHDOD (IL)

(21) Appl. No.: 12/530,973

(22) PCT Filed: Mar. 12, 2008
(86) PCT No.: PCT/IL08/00339

§ 371 Date: Nov. 19, 2010

(30) Foreign Application Priority Data
Mar. 12, 2007 (IL) 181853
Mar. 12, 2007 (IL) 181854

(51) Int. Cl. G01V 1/28

(52) U.S. Cl. 367/74; 702/14

(57) ABSTRACT

Sensor unit for detecting a motorized object producing a seismic or acoustic signal in the form of at least one spectral line, comprising at least one seismic sensor or at least one acoustic sensor for collecting a signal, an analog-to-digital converter for receiving said signal and generating a digital signal, a memory for storing portions of said digital signal, and a processing unit configured for performing the following operations: generating a first set of Fast Fourier Transform (FFT) values indicative of a portion of to said signal, associating said first set of FFT values with a second set of values being a partition, calculating an entropy value H of said partition, repeating the above operations, thereby constituting a sequence of entropy values H(t) corresponding to a plurality of portions of said signal, and determining a detection in case a predetermined criterion is met, said criterion is based at least on said sequence of entropy values, thereby enabling detecting of said seismic or acoustic signal.

### FIELD OF THE INVENTION

This invention relates to detection of motorized objects e.g. land vehicles, stationary motors and the like.

### BACKGROUND OF THE INVENTION

Sensor units such as Unattended Ground Sensors (UGS) facilitate the detection and classification of vehicles by utilizing sensors such as acoustic, magnetic or seismic sensors to monitor the environment. UGS devices are used for diverse tasks such as perimeter defense, wildlife protection and situation awareness. Since UGS devices often operate in remote or even hostile environments, they are usually self supporting devices powered by autonomous power units and equipped with the ability to report detection by transmitting a detection signal. Economic power consumption is crucial since the device is then operable for a longer time before power unit is shut-down or replacement is required. In addition, miniaturization is also preferable as miniature UGS devices are easy to deploy. The information a UGS generates may be transmitted to a remote station.

One of the challenges faced by the designers of UGS devices is the ability to reduce False Alarm Rate (FAR) and increase the Probability of Detection (PD) and detection range. Low Probability of Detection may result in critical events passing unnoticed. High False Alarm Rate may trigger a lot of unnecessary responses which quite often have the operators of any alarm system eventually shut down the system (when the alarm system is shutdown, PD=0). Additionally, high FAR increases power consumption due to the extra energy used to transmit the detection signal. Therefore, a plurality of methods are known in the art aimed at processing the sensed signal in the UGS itself in order to accurately identify true signals, resulting from objects of interest (such as signals resulting from vehicles), while ignoring non-relevant signals, such as background noise or random noise. Despite the fact that more sophisticated processing methods may lead to lower FAR and higher PD and detection range, they pose a problem since the complexity of the calculation increases and so does the UGS power consumption.

U.S. Pat. Nos. 3,745,552, 3,686,658, 3,696,369, 3,879,720, 3,913,085, 4,110,730, 4,223,304, 4,521,7685, 483,222, 5,493,273, 6,288,395 and 6,928,030 relate to the field of detection and classification of objects.

U.S. Pat. Nos. 5,243,686, 6,519,355, 6,985,815, 6,816,744; US Patent Application Nos. 2007010795, 2006281999; and PCT Patent Application No. WO04036804 relate to the use of Entropy function in signal processing.

There is therefore a need in the art for efficient detection and classification of objects which involves a reduced number of calculations in the processing of propagating signals such as seismic and acoustic signals. There is also a need in the art for an improved UGS capable of carrying out an improved processing method. There is still further a need in the art for a small scale UGS which is efficient, power-saving and long-lasting, and which provides high probability of detection and low false alarm rates.

### SUMMARY OF THE INVENTION

The present invention provides a detection apparatus, system and method which allow detection of physical phenomena characterized by at least one spectral line in the frequency-time domain. According to an embodiment of the invention, a motorized objects such as vehicles and stationary motors, producing a seismic or acoustic signal in the form of at least one spectral line is detected based on analysis of acoustic or seismic signals generated by the object.

In accordance with an embodiment of the present invention there is provided a detection apparatus—a sensor unit, e.g. an Unattended Ground Sensor (UGS), for detecting a motorized object producing a seismic or acoustic signal in the form of at least one spectral line, comprising:
at least one seismic sensor or at least one acoustic sensor for collecting a signal;
an analog-to-digital converter for receiving said signal and generating a digital signal;
a memory for storing portions of said digital signal; and
a processing unit configured for performing the following operations:
   (i) generating a first set of Fast Fourier Transform (FFT) values indicative of a portion of said signal;
   (ii) associating said first set of FFT values with a second set of values being a partition;
   (iii) calculating an entropy value H of said partition;
   (iv) repeating said operations (i)-(iii) thereby constituting a sequence of entropy values H(t) corresponding to a plurality of portions of said signal, and determining a detection in case a predetermined criterion is met, said criterion is based at least on said sequence of entropy values, thereby enabling detecting of said seismic or acoustic signal.

According to another embodiment of the invention there is provided a computerized method for detecting a seismic or acoustic signal in the form of at least one spectral line, comprising:
(i) receiving a first set of Fast Fourier Transform (FFT) values indicative of a portion of seismic or acoustic signal;
(ii) associating said first set of FFT values with a second set of values being a partition;
(iii) calculating an entropy value H of said partition; and
(iv) repeating said operations (i)-(iii) thereby constituting a sequence of entropy values corresponding to sequential portions of said signal, and indicating a detection according to a predetermined criterion, said criterion is based at least on said sequence of entropy values, thereby enabling detecting of said seismic or acoustic signal.

According to an embodiment of the present invention there is provided a computer program comprising computer program code means for performing the following operations, when said program is executed on a computer:
receiving a first set of Fast Fourier Transform (FFT) values indicative of a portion of seismic or acoustic signal;
associating said first set of FFT values with a second set of values being a partition;
calculating an entropy value H of said partition; and
repeating said operations (i)-(iii) thereby constituting a sequence of entropy values corresponding to sequential portions of said signal, and indicating a detection according to a predetermined criterion, said criterion is based at least on said sequence of entropy values, thereby enabling detecting of said seismic or acoustic signal, if such signal exists.

According to yet another embodiment of the invention there is provided a computerized method for detecting a seismic or acoustic signal in the form of at least one spectral line, comprising:
receiving a digital representation indicative of a time-framed portion of seismic or acoustic signal;
calculating an entropy value H of said digital representation;
repeating said calculating for a succession of time-framed portions of said signal; and
indicating a detection in case a similarity criterion is met with respect to part of said time-framed portions, said similarity criterion is based at least on an entropy reference value and on said entropy values H or derivatives thereof, thereby enabling detecting of said seismic or acoustic signal, if such signal exists.

According to an embodiment of the present invention there is provided a computer program comprising computer program code means for performing the following operations, when said program is executed on a computer:
receiving a digital representation indicative of a time-framed portion of seismic or acoustic signal;
calculating an entropy value H of said digital representation;
repeating said calculating for a succession of time-framed portions of said signal; and
indicating a detection in case a similarity criterion is met with respect to part of said time-framed portions, said similarity criterion is based at least on an entropy reference value and on said entropy values H or derivatives thereof, thereby enabling detecting of said seismic or acoustic signal, if such signal exists.

### BRIEF DESCRIPTION OF THE DRAWINGS

In order to understand the invention and to see how it may be carried out in practice, certain embodiments will now be described, by way of non-limiting example only with regard to detection of motorized objects and with reference to the accompanying drawings, in which:

FIG. 1 is a block diagram schematically illustrating an apparatus according to an embodiment of the present invention;

FIG. 2 is a flowchart showing a sequence of operations carried out by an apparatus according to an embodiment of the present invention;

FIGS. 3a-3b, 4a-4b and 5a-5b are graphical representations illustrating some of the operations carried out by an apparatus according to an embodiment of the present invention;

FIG. 6 is a schematic illustration of a processing unit according to an embodiment of the present invention;

FIG. 7a is a flowchart showing a sequence of operations according to an embodiment of the present invention;

FIG. 7b is a flowchart showing another sequence of operations according to an embodiment of the present invention; and

FIG. 8 is another graphical representation illustrating some of the operations carried out by a sensor unit according to an embodiment of the present invention.

### DETAILED DESCRIPTION OF EMBODIMENTS

In the following, the principles of the present invention will be mainly described with respect to an embodiment of the invention implementing a UGS (Unattended Ground Sensor). There will be described a UGS that carries out all detection operations in a completely autonomous manner, in real-time, and which notifies a remote station with a detection signal, when required. This embodiment is denoted hereinafter as ‘autonomous UGS’. It should be understood that the invention is not limited to the ‘autonomous UGS’ embodiment and many other embodiments are possible, including, but not limited to, various allocations of operations between one or more UGS devices and other types of remote units, and off-line systems and methods. The present application is further not limited to a UGS device and can be implemented as a sensor unit suitable for many other applications and devices.

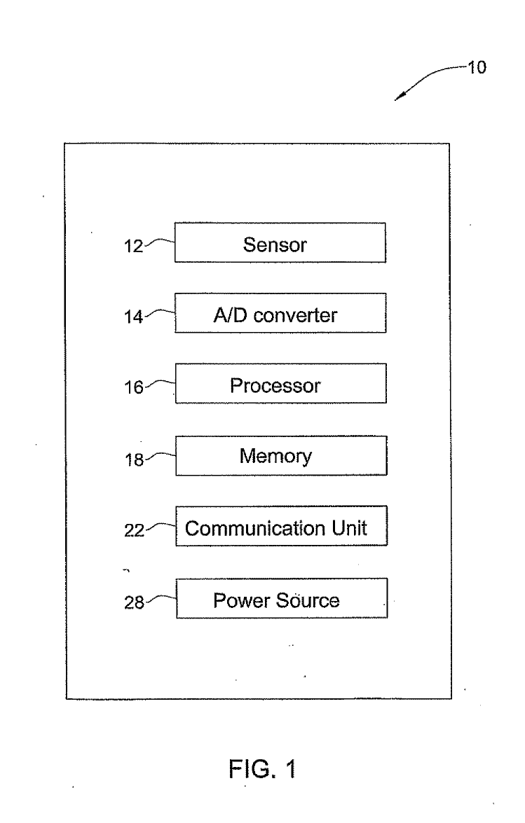

FIG. 1 is a block diagram schematically illustrating a sensor unit 10 (e.g. a UGS) according to an embodiment of the present invention (‘autonomous UGS’). Unit 10 includes, inter-alia, at least one acoustic or seismic (geophone) sensor 12 for collecting acoustic or seismic signals; at least one Analog to Digital (AID) converter 14 for converting the collected acoustic or seismic analog signal to a digital signal; processing unit (processor) 16 for processing the digital signal by executing algorithms stored on memory 18, and for detecting (and according to certain embodiments of the invention, also classifying) an object causing an acoustic or seismic signal in the vicinity of the UGS. UGS 10 further comprises communication unit 22 (e.g. a transmitter and an antenna) operable by the processor 16 to notify a remote station in case of detection. All elements 12-22 are powered by a local power source 28 which is typically a battery. According to certain embodiments of the present invention, all electronic elements are implemented as a single electronic module.

Not shown in FIG. 1 are some other co-located sensors (e.g. magnetic sensors) which may be operated in parallel or in combination with part or all of the elements of sensor unit 10 shown in FIG. 1. In order to clarify explanations, FIG. 1 illustrates only those elements required to present the principles of the present invention. It should be understood that the present invention is not limited by the illustrated configuration. According to an embodiment of the invention, there are used an acoustic sensor, a seismic sensor and perhaps another sensor (e.g. magnetic sensor), each providing a signal analyzed by e.g. a common processor using a common on-chip memory and fed by a common battery. According to one embodiment of the invention, communication unit 22 includes a transmitter and an antenna capable of communicating with a remote monitoring station, relay units (e.g. transceivers in the vicinity of the UGS) and more. According to another embodiment of the invention, communication unit 22 includes a transceiver and antenna, thereby allowing the UGS 10 to e.g. receive commands from a remote station or to engage with other UGS in networked operating mode.

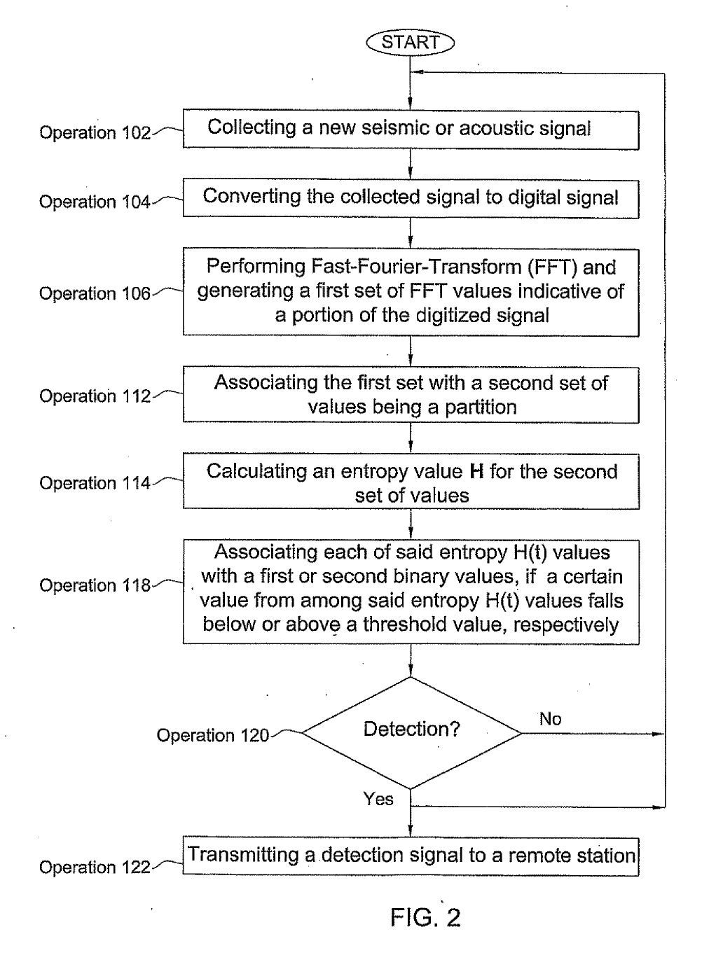

The operation of sensor unit 10 will now be described with reference to FIGS. 1, 2, 3a-3b and 4a-4b: FIG. 2 is a flowchart showing a sequence of operations 100 carried out in a substantially continuous manner by e.g. unit 10 shown in FIG. 1, according to an embodiment of the invention.

At operation 102, seismic or acoustic signal is collected by the sensor (element 12 shown in FIG. 1). As the unit—and the sensor—typically operates in a continuous manner, the sequence of operations 100 is continuously advanced in response to receiving the next portion of collected signal. The collected signal may include signals, portions or patterns of interest, caused by e.g. a motor, a vehicle, etc.; other signals, which are not of interest, and background noise. As will now be detailed, according to one of its aspects, the present invention provides a method for detecting the occurrence of a signal of interest by efficiently distinguishing between the signal of interest—being in the form of at least one spectral line—and other signals (e.g. background).

At operation 104: the new portion of collected seismic or acoustic signal is sampled and converted into digital format by the A/D converter (element 14 shown in FIG. 1), giving rise to a digital signal. Portions of the digital signal are stored on the on-chip memory (element 18 shown in FIG. 1).

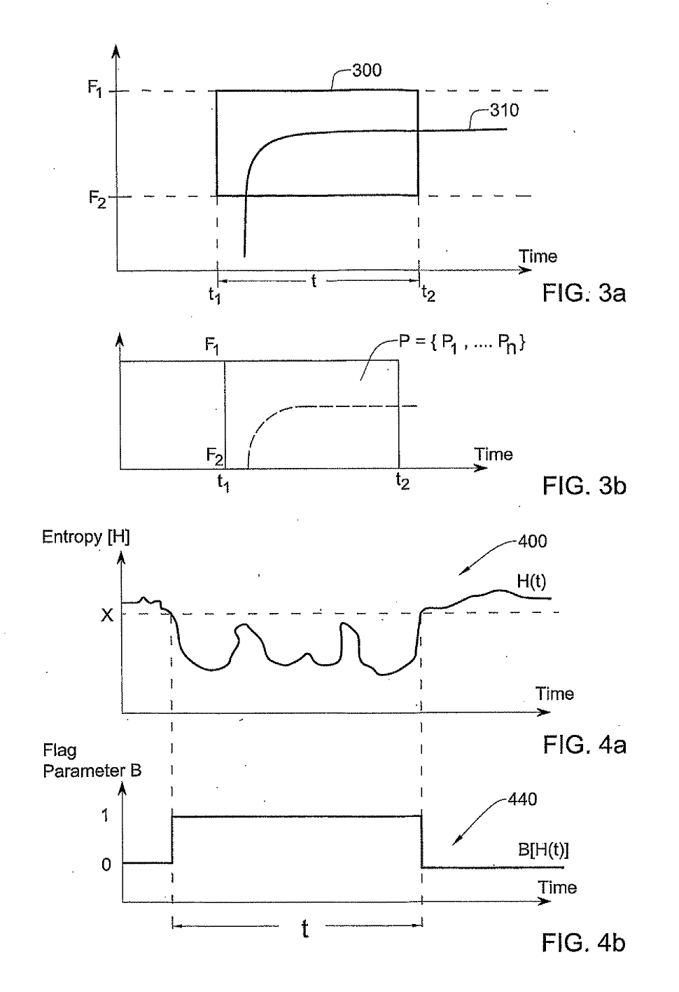

At operation 106: performing Fast-Fourier-Transform (FFT) and generating a first set of FFT values indicative of the new portion of the digitized signal. Operation 106 will now be explained with reference to FIG. 3a, which is a graphical representation showing an illustration of a FFT spectrogram (frequency-time domain): frame 300 represents a set of FFT values corresponding to a certain signal portion being processed in a certain cycle of operation. Frame 300 is defined by frequencies F₁ and F₂, and time points t₁ and t₂. Frequencies F₁ and F₂ may be selected in advance—in accordance with known characteristics of the signal of interest or other operational considerations, or defined dynamically. Non-limiting F₁, F₂ values are 70 Hz and 100 Hz respectively. Due to the continuous operation of the UGS, time boundaries t₁ and t₂ are dynamic, and frame 300 is actually a sliding window screening the digitized format of the continuous collected signal. Window's width t may also be predetermined or adjustable dynamically. Non-limiting t values are 1 second or 2 seconds.

Spectral line 310 represents schematically the signal of interest, caused e.g. by a vehicle passing in the vicinity of the UGS. For simplicity of explanation, only one spectral line is presented, however in reality more than one spectral line may be caused by the object. Further, it is clear that in reality, spectral line 310 is typically not smooth and clear. Not shown in FIG. 3 are representations of values which do not correspond to spectral line 310 (e.g. noise, signals not of interest). The present invention is preferably useful for detection of objects that produce an acoustic or seismic signal having at least one spectral line in the frequency-time domain. In order to be detected, the object must present continuous behavior at least for a certain time frame. An example would be signals caused by a vehicle's motor or by the friction of a vehicle's tires with a road. As will be detailed further below, the present invention provides an efficient, credible, low-complexity method for detecting the presence of values corresponding to spectral lines (e.g. spectral line 310) within the set of FFT values corresponding to frame 300. This will now be explained with reference to FIGS. 2, 3a-3b and 4a-4b.

At operation 112: the first set of FFT values generated in operation 106 (graphically represented by frame 300 in FIG. 3a) is normalized, that is associated with a second set of values (partition). This is graphically represented in FIG. 3b by the partition P={p₁, . . . pₙ} where n is the total number of FFT values ak's within the frame (matrix) 300 in FIG. 3a. For each k=1, . . . n pk=ak/S where S is the sum of all these ak's. This means that P is a partition i.e. each pk is between zero and one and their sum is equal to 1.

At operation 114: an entropy denoted by H is calculated for the partition (the second set of values) e.g. based on the following function:

H(P)=−Σᵢ₌₁ⁿ(pᵢ*log pᵢ) (1)

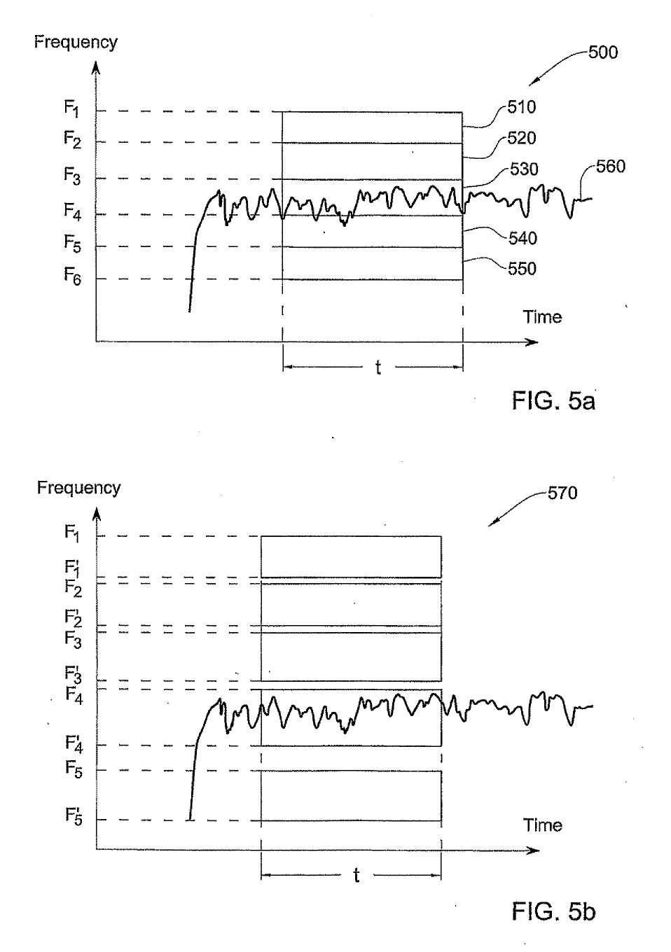

Operations 112 and 114 are carried out substantially in a continuous manner over time, hence giving rise to a sequence of entropy values H(Pt), corresponding to sequential partitions Pt (illustrated in FIG. 3b), in turn corresponding to sequential frames 300 (illustrated in FIG. 3a), corresponding each to a portion of a digitized signal. Principally, any change in the entropy value between one frame to another may indicate a change in the collected signal. Frames (or a sequence of frames) having relatively high entropy values may indicate acoustic or seismic noise. Frames (or a sequence of frames) having relatively low entropy values may indicate any non-uniformity in the frequency domain, e.g. a spectral line. Put differently, continuous operations 114 give rise to a sequence of entropy values over time, H(t). This is graphically represented in FIG. 4a, showing the sequence of entropy values H(t) 400 received by a sequence of operations 114 over time.

At operation 118: each entropy value H(t) is associated with a first or a second binary value (e.g. “1” or “0”), in accordance with the relation between each value H(t) and a threshold value x, as determined for example, by relation (2):

B(H(t))=0 if H(t)≧x and B(H(t))=1 if H(t)<x; (2)

This is graphically illustrated in FIGS. 4a and 4b: between certain time points the entropy H(t) drops below the threshold value x. A flag parameter B is assigned the value “1” for as long as the entropy value is below the threshold value x, and the value “0” as long as the entropy value is above the threshold value x.

At operation 120: checking the values of several consecutive flag parameter B and in case they fulfill a predetermined criterion, defining a detection of a signal of interest. This could be done e.g. by assigning a detection flag parameter (also denoted hereinafter as “a binary marker” or “binary value”) the value “1” in case the flag parameter B carries the value “1” for at least a predetermined period of time. According to another embodiment of the invention, the predetermined criterion requires that the flag parameter B carries the value “1” for at least a predetermined period of time in any given time frame. It should be understood that many rules can be implemented in accordance with various operational considerations to define the detection of the signal of interest.

At operation 122: in response to detection, transmitting a corresponding signal to a remote unit.

As mentioned above, the sequence of operations 100 is carried out in a substantially continuous manner. According to one embodiment of the invention, each operation 112 (associating a set of FFT values with partition) is carried out with respect to consecutive digitized portions corresponding to consecutive portions of the collected signal. By this, full coverage of the collected signal is obtained. According to another embodiment of the invention, certain overlapping is provided between consecutive digitized portions corresponding to consecutive portions of the collected signal, giving rise to a better resolution. According to yet another embodiment of the invention, only part of the collected signal is analyzed (sampled), giving rise to a more power-saving operation.

In the above-detailed sequence of operations 100, there is no use of values corresponding to the energy (amplitude) of the detected signal. This is possible because the entropy-based sequence of operations 100 has no dependency on the energy (amplitude) parameter. Even weak and very weak signals can be considered. As a result of this fact, better detection range is obtained. In experiments where seismic sensors were used according to certain embodiments of the invention, vehicles at a distance of 1 km and more were successfully detected.

The present invention provides a method and system capable of entropy-based, efficient detection with relatively increased Detection Probability (PD), increased detection range and relatively law False Alarm Rate (FAR), involving reduced computational complexity. Low FAR and high PD obtained in accordance with the present invention allows for efficient operation, efficient power consumption, miniaturization of components and reduced hardware demands.

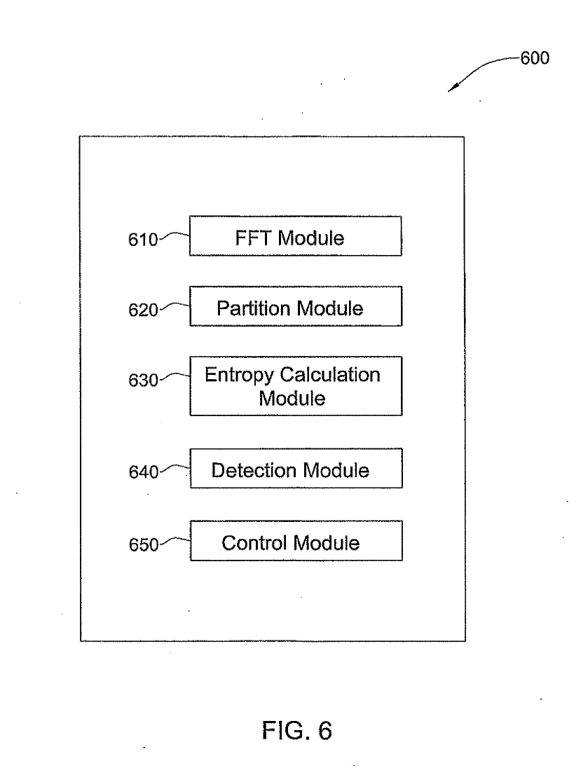

Better Signal to Noise Ratio (SNR) and consequently, better PD can be achieved by scanning the sampled signal portions with multiple frames (windows) over the same frequency range. This will now be detailed with reference to FIGS. 5a-5b.

As described above with respect to operation 106 and best illustrated in FIG. 3a, processing of the digitized signal is carried out with respect to a single sliding window (frame 300 shown in FIG. 3a, ‘single window’ or ‘time-framed’ embodiment). It should be clear that the invention is not limited by the illustrated embodiment and other embodiments are possible within the scope of the invention. In accordance with certain embodiments of the present invention, signal analysis is carried out with respect to a multiplicity of sliding windows (‘multiple windows’ or ‘frequency-framed’ embodiment), substantially in parallel. This is graphically illustrated in FIGS. 5a-5b. FIG. 5a shows a FFT spectrogram (frequency-time domain) 500 and a multiplicity of frames 510-550 (5 frames in this non-limiting example), defined by boundary frequencies F₁-F₆. In this non-limiting example, frames 510-550 cover the entire frequency range F₁-F₆. It should be understood that the invention is not limited by the exemplified embodiment, and other embodiments are possible e.g. as illustrated in FIG. 5b in a self-explanatory manner. According to another embodiment of the invention and various operational considerations, only selected frequency range is processed, e.g. F₃-F₄, where spectral line 560 of a specific object of interest is expected to occur.

According to an embodiment of the invention, the analysis of each frame (e.g. frames 510-550 illustrated in FIG. 5)—as detailed above with respect to operations 106-120 illustrated in FIG. 2—is carried out substantially in parallel. In accordance with one embodiment of the invention, a detection is defined (at operation 120) in case the binary mark of at least one frequency range (e.g. sliding window 530, running in the F₃-F₄ range, illustrated in FIG. 5a) fulfills a predetermined criterion. In accordance with another embodiment, suitable to a case where at least two spectral lines are expected to occur at different frequency windows, another detection criterion is set in advance, e.g. to allow definition of detection only in case at least two binary marks—those relating to the different windows in which the spectral line in present—each fulfills its respective detection criterion. According to another embodiment of the invention, the detection criterion is designed as follows: each set of multiple windows, e.g. five parallel frames as illustrated in FIGS. 5a-5b in a non limiting manner, specifies a vector of five entropy values, constituting an entropy vector. The binary marker is assigned its value with respect to the minimum of the five entropy values, e.g. in case the minimal vector value is below or above some predetermined threshold. Along the time line one obtains a binary vector for which a predetermined criterion is defined for detection.

According to another non-limiting example in accordance with an embodiment of the invention, detection is defined in case a binary mark criterion and at least one other criterion are met, for example:

At operation 118: per first set from among said multiplicity, associating each of the entropy H(t) marks with a first or second binary value, if a certain mark from among said entropy H(t) marks falls below or above a threshold value, respectively. As this operation is carried out substantially in parallel for each frame, the outcome is a multiplicity of binary markers, each corresponding to a respective frame.

At operation 120: defining detection in case the first binary value is obtained for a predetermined duration of time in at least one binary marker from among the multiplicity of binary markers. In other words, the rule applied in the above detailed example allows definition of detection in case at least one spectral line is discovered in a certain frequency frame over time. It should be understood that many other rules may be selected without departing from the scope of the present invention.

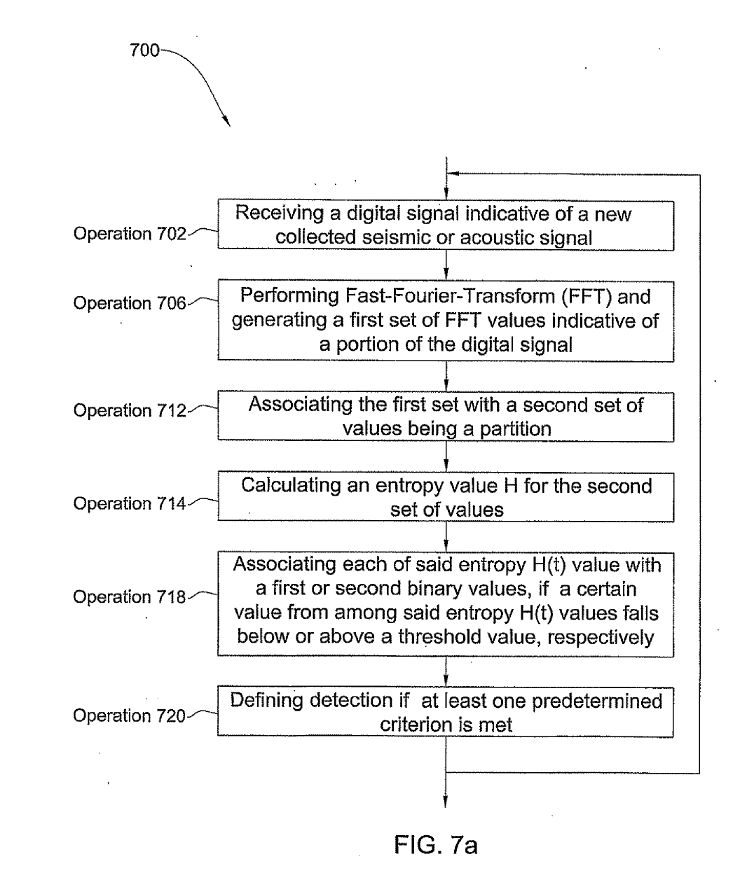

In the above description, the present invention was mainly described with respect to an ‘autonomous UGS’, where all computational operations are carried out locally. FIG. 6 is a schematic illustration of a processing unit 600 capable of performing all computational operations required in accordance with the ‘autonomous UGS’ embodiment of the invention. Processing unit 600 includes, inter-alia, the following elements: FFT module 610; Partitioning module 620; Entropy calculation module 630; Detection module 640 and Control module 650. With respect to FIG. 2, FFT module 610 is configured to perform operation 106. Partitioning module 620 is configured to perform operation 112—converting a set of FFT values to a partition, either for a single frame or for a multiplicity of frames in parallel. Entropy calculation module 630 is configured to perform operations 114—calculating an entropy value to each frame, and operation 118—assigning values to each binary marker corresponding to a frame, either for a single frame or for a multiplicity of frames substantially in parallel. Detection module 640 is configured to perform operation 120—executing the predefined criterion/criteria and, as the case may be, additional detection rule/s. In case the operation of detection includes also the operation of classification (this will be discussed further below), the classification operation is also performed by Detection module 640 can be assigned with additional tasks, as may be required by various operational needs. The Control module 650 is configured, in case of detection, to activate the communication unit (element 22 illustrated in FIG. 1) for notifying a remote station. In accordance with an embodiment of the invention where the UGS is capable of receiving commands from a remote unit (e.g. a control station or another UGS), the control module 650 is further configured for affecting the operation of the other module accordingly. Non-limiting examples of the above involve e.g. dynamically changing the entropy threshold (e.g. value x illustrated in FIG. 4a), the boundary frequencies defining the frame/s (e.g. frequencies F1-F2 illustrated in FIG. 3a), and more. The Control module 650 can be assigned with additional tasks, as may be required by various operational needs.

According to the ‘autonomous UGS’ embodiment of the invention described above mainly with reference to FIGS. 1 and 2, all computational operations are locally performed. It should be understood that the invention is not limited thereto and other schemes of operations allocation are possible within the scope of the present invention. For example, according to certain embodiments of the invention and in order to satisfy certain operational needs, certain operations are allocated to a remote unit. According to another embodiment of the invention, where power considerations are less stressing, the UGS transmits signals indicative of the detected signal to a remote unit and part or all of the calculations are performed remotely from the sensor. According to yet another embodiment of the invention, all calculations are performed off-line.

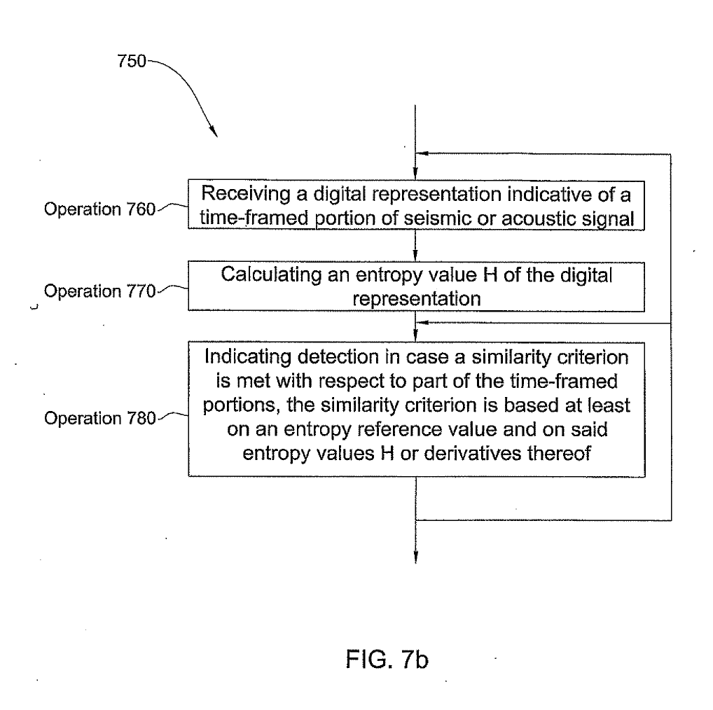

According to an aspect of the present invention, there is provided a computer program comprising computer program code means for performing the following sequence of operations 700 in substantially continuous manner, e.g. as illustrated in FIG. 7a:

At operation 702: Receiving a digital signal indicative of a collected seismic or acoustic signal.

At operation 706: Performing Fast-Fourier-Transform (FFT) and generating a first set of FFT values indicative of a portion of the digital signal. According to one embodiment of the invention, the portion is defined by time (“frame”), where in each cycle of operation, portions relating to different time intervals are processed. According to different embodiments of the invention, the portions may overlap to some degree with each other, be consecutive or distinct with respect to each other. According to another embodiment of the invention, the portions are defined by boundary frequencies. According to yet another embodiment of the invention, per each cycle of operation (corresponding to a specific time interval), parallel portions (“frames”) are defined by three or more boundary frequencies, and are processed substantially in parallel.

At operation 712: Associating the first set of FFT values with a partition (a second set of values).

At operation 714: Calculating an entropy value H for the second set of values.

At operation 718: Associating each of said entropy H(t) values with a first or second binary value, if a certain value from among said entropy H(t) values falls below or above a threshold value, respectively.

At operation 720: Defining detection if at least one predetermined criterion is met.

According to a more generalized embodiment of the present invention, the following sequence of operations 750 illustrated in FIG. 7b is performed in order to detect the presence of a seismic or acoustic signal having a spectral line:

In operation 760: receiving a digital representation indicative of a time-framed portion of seismic or acoustic signal.

In operation 770: calculating an entropy value H of said digital representation.

Operations 760 and 770 are repeated with respect to a succession of time-framed portions of said signal. The above-mentioned succession may correspond to consecutive portions of signals, or to somewhat overlapping portions. Further, with respect to each time frame, a multiplicity of frequency-framed portions of signal could be analyzed.

In operation 780: indicating detection in case a similarity criterion is met with respect to part of said time-framed portions, the similarity criterion is based at least on an entropy reference value and on said entropy values H or derivatives thereof (e.g. a binary flag).

According to an embodiment of the invention, checking whether the similarity criterion is met includes checking whether the entropy values H (directly or indirectly, using derivatives thereof) are different from or equal to at least one reference value. According to an embodiment of the invention, the reference value is indicative of the background noise (clutter) of a specific scene. The reference value could be pre-determined, determined during a provisioning operation or dynamically determined. According to another embodiment of the invention, the reference value is indicative of an entropy value corresponding to a specific motorized object of interest.

According to another embodiment of the invention, checking whether the similarity criterion is met includes checking whether substantially similar entropy values (or derivatives thereof) are obtained with respect to at least a succession of calculations, corresponding to successions of time-framed portions of seismic or acoustic signals.

Operations 702-712 illustrated in FIG. 7a, as well as operations 104-112 illustrated in FIG. 2 are thus performed in order to generate the digital representation mentioned above with respect to operation 760. It should be understood that the invention is not limited by the illustrated examples and many other ways can be used for generating digital representations indicative of the analyzed signal, without departing from the scope of the present invention.

It should be understood that the performance of the method according to any of the embodiments of the present invention not necessarily ends upon detection of the presence of the signal of interest. According to certain embodiments of the invention, all operations are continuously performed from start of operation as long as new portions of signals or new digital representations (as the case may be) are incoming, or until power shutdown (e.g. when the detection apparatus is autonomously powered). According to another embodiment of the invention, other end events (not illustrated in any of FIGS. 2, 7a and 7b) are determined. It should be understood that the invention is not limited by the type and design of either the start event or end event.

According to an aspect of the present invention, the above detailed programs are executed on a computer. According to an embodiment of the invention, the programs are executed on a single computer. According to another embodiment of the invention, certain operations are allocated to different computers (processing units) wherein output of a certain operation carried out by one computer is communicated to another computer as an input to a respective operation carried out by the other computer. According to an aspect of the present invention, the computer program is embodied on a computer readable medium.

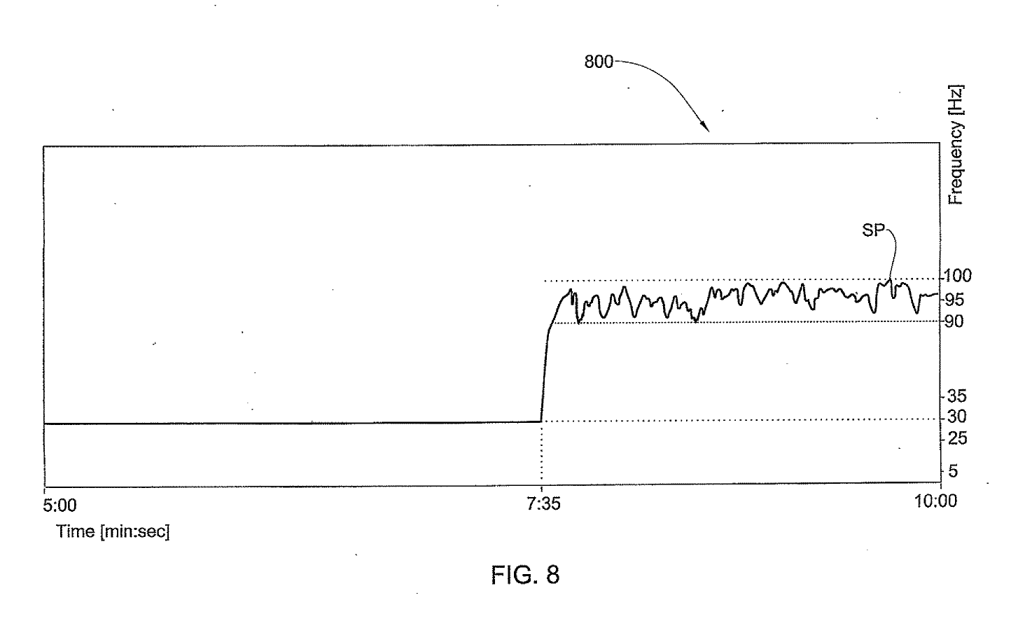

In accordance with various operational needs, the selection of the single frame (e.g. boundary frequencies F₁-F₂ illustrated in FIG. 3a) or multiple frames (e.g. as illustrated in FIGS. 5a-5b) allows for classification of the object of interest. This will now be explained with respect to FIG. 8, showing a frequency-time representation 800 of a collected signal of a vehicle (e.g. a truck) during a few minutes. The behavior of the spectral line SL corresponds to the performance of the truck's motor, e.g. linearly depends upon the motor's Rounds-Per-Minutes (RPM) parameter. Between time point 5:00 min to 7:35 min, a portion of the spectral line SP is received at 30 Hz, corresponding to neutral gear of the truck's motor (operating it without moving the truck). At time point 7:35 the truck begins its movement and consequently, a spectral line is received in the 90-100 Hz range. It is possible to correlate between the frequency value that is obtained and an RPM value using an empiric constant, and thus using the calculated RPM value (up to some constant) for classification of the vehicle and/or its behavior.

Thus, according to an embodiment of the invention, classification of the specific motorized object—a truck in the non-limiting example of FIG. 8 could be achieved e.g. by selecting specific boundary frequencies—90-100 Hz in that non-limiting example, that matches the specific truck's typical RPM. According to another embodiment of the invention, the presence of a specific object is defined if its respective spectral lines are detected in correlation, e.g. a 30 Hz portion followed by a 90-100 Hz portion. According to another embodiment of the invention, fluctuation of the spectral line e.g. in the 90-100 Hz range, indicating gear operations, may be analyzed and counted to facilitate classification. Many other classification schemes are possible within the scope of the present invention, including classification based on use of a single frame only.

It is a known phenomenon that amplifiers give rise to duplications of an original, collected signal (the so-called ‘harmonics’). According to certain embodiments of the invention amplifiers are used (e.g. as part of the sensor collecting the signal) and give rise to signal duplications. According to an embodiment of the invention the duplications are eliminated by appropriate selection of the frequency boundaries of the sliding windows. According to another embodiment of the invention, the detection of a spectral line of a motorized object is carried out by processing not only the original signal but rather together with the signal's duplication's.

In the above description, the practical problem of detecting the presence of a motor characterized by acoustic and/or seismic signature having relatively low frequencies of about 0-150 Hz was addressed, and the concepts of the present invention were presented with respect to this practical problem. As described above, the present invention is suitable for the detection of seismic and acoustic signals having the form of a spectral line in the frequency-time domain, and thus is suitable to solve the above-mentioned practical problem. It should be understood that the invention is not limited to the above practical problem and its typical constrains, and can be useful for other detection tasks. It therefore should be clear that the invention is not limited by the range of frequencies and can be applied to any frequency range. Moreover, the invention is not limited to the detection of motorized objects and can be used to detect any object is that produces a continuous (i.e. continuous for a certain time period) seismic and/or acoustic signal. It should further be understood that the invention is not limited to the detection of spectral lines and can be used for the detection of other forms of continuous seismic and acoustic signals, which give rise to non-uniformity in the frequency domain. It should also be clear that the invention is not limited to the detection of seismic or acoustic signal and is useful for detecting any other type of propagating wave.

It will also be understood that the systems according to the invention may be suitably programmed computers. Likewise, the invention contemplates computer programs being readable by a computer for executing the methods of the invention. The invention further contemplates a machine-readable memory tangibly embodying a program of instructions executable by the machine for executing the method of the invention.

1. Sensor unit for detecting a motorized object producing a seismic or acoustic signal in the form of at least one spectral line, comprising:
at least one seismic sensor or at least one acoustic sensor for collecting a signal;
an analog-to-digital converter for receiving said signal and generating a digital signal;
a memory for storing portions of said digital signal; and
a processing unit configured for performing the following operations:
(i) generating a first set of Fast Fourier Transform (FFT) values indicative of a portion of said signal;
(ii) associating said first set of FFT values with a second set of values being a partition;
(iii) calculating an entropy value H of said partition;
(iv) repeating said operations (i)-(iii) thereby constituting a sequence of entropy values H(t) corresponding to a plurality of portions of said signal, and determining a detection in case a predetermined criterion is met, said criterion is based at least on said sequence of entropy values,
thereby enabling detecting of said seismic or acoustic signal.

2. A sensor unit according to claim 1 wherein said motorized object is a motor vehicle or a stationary object.

3. A sensor unit according to claim 1 further comprising a communication unit operable by said processing unit for notifying a remote unit in response to a detection of said object.

4. A sensor unit according to claim 3 wherein said communication unit is further operable for receiving communication.

5. A sensor unit according to claim 1 wherein said generating includes:
(ia) generating a first set of Fast Fourier Transform (FFT) values indicative of a portion of said signal defined by pre-selected boundary frequencies.

6. A sensor unit according to claim 1 wherein said operation (i) includes:
(ia) generating a multiplicity of first sets of Fast Fourier Transform (FFT) values indicative of a portion of said signal, each defined by pre-selected boundary frequencies;
and wherein said operations (ii)-(iii) are carried out with respect to each first set in said multiplicity of first sets.

7. A sensor unit according to claim 1 wherein said predetermined criterion is met when a predetermined number of said entropy values H(t) falls below a threshold for a predetermined duration of time.

8. A sensor unit according to claim 1 wherein said indicating includes:
(iv) associating each of said entropy H(t) values with first or second binary values, if a certain value from among said entropy values H(t) falls below or above a binary threshold, respectively; and
(v) defining detection in case said first binary value is obtained for a predetermined duration of time.

9. A sensor unit according to claim 6 wherein said indicating includes:
(iv) per set from among said multiplicity, associating each of said entropy H(t) values with a first or second binary values, if a certain value from among said entropy H(t) values falls below or above a threshold, respectively, thereby constituting a multiplicity of binary values; and
(v) defining detection in case said in case a predetermined criteria is met by said multiplicity of binary values.

10. A sensor unit according to claim 7 wherein said threshold is dynamically determined.

11. A sensor unit according to claim 7 wherein said threshold is predetermined.

12. A sensor unit according to claim 1 wherein said repeating is carried out such that said operations (i)-(iii) are carried out with respect to consecutive portions of the digital signal.

13. A sensor unit according to claim 1 wherein said repeating is carried out such that a part of each set corresponding to a portion overlaps with a part of a set corresponding to a previous or a consecutive portion.

14. A sensor unit according to claim 1 being an Unattended Ground Sensor (UGS).

15. A computerized method for detecting a seismic or acoustic signal in the form of at least one spectral line, comprising:
(i) receiving a first set of Fast Fourier Transform (FFT) values indicative of a portion of seismic or acoustic signal;
(ii) associating said first set of FFT values with a second set of values being a partition;
(iii) calculating an entropy value H of said partition; and
(iv) repeating said operations (i)-(iii) thereby constituting a sequence of entropy values corresponding to sequential portions of said signal, and indicating a detection in accordance with a predetermined criterion, said criterion is based at least on said sequence of entropy values,
thereby enabling detecting of said seismic or acoustic signal.

16. A method according to claim 15 further comprising:
(v) associating each of said entropy H(t) values with one of two possible binary values, respectively, if a certain value from among said entropy H(t) values falls below or above a threshold; and
(vi) defining detection in case said first binary value is obtained for a predetermined duration of time.

17. A method according to claim 15 wherein said threshold is dynamically determined.

18. A method according to claim 15 wherein said threshold value is predetermined.

19. A method according to claim 15 wherein said repeating is carried out such that operations (i)-(iii) are carried out on a plurality of first sets corresponding to consecutive portions of said seismic or acoustic signal.

20. A method according to claim 15 wherein said repeating is carried out such that each first set, corresponding to a portion, overlaps with a part of a first set corresponding to a previous or a consecutive portion.

21. A method according to claim 15 wherein said operation (i) includes:
(ia) receiving a first set of Fast Fourier Transform (FFT) values indicative of a portion of said signal defined by pre-selected boundary frequencies.

22. A method according to claim 15 wherein said operation (i) includes:
(ia) receiving a multiplicity of first sets of Fast Fourier Transform (FFT) values indicative of a portion of said signal, each defined by pre-selected boundary frequencies.

23. A method according to claim 15 further comprising:
(vii) transmitting a corresponding signal to a remote station in response to defining a detection.

24. A method according to claim 15 wherein said predetermined criterion is met when part of said entropy values falls below a threshold for a predetermined duration of time.

25. A method according to claim 15 wherein said indicating includes:
(vi) associating each of said entropy H(t) values with a first or second binary values, if a certain value from among said entropy H(t) values falls below or above a threshold, respectively; and
(vii) defining detection in case said first binary value is obtained for a predetermined duration of time.

26. A method according to claim 15 wherein said indicating includes:
(iv) per set from among said multiplicity, associating each of said entropy H(t) values with a first or second binary values, if a certain value from among said entropy H(t) values falls below or above a threshold, respectively, thereby constituting a multiplicity of binary values; and
(v) defining detection in case a predetermined criterion is met, said criterion is based at least on said multiplicity of binary values.

27. A method according to claim 15 wherein at least operations (i)-(iv) are carried out by an Unattended Ground Sensor (UGS) having limited power and processing sources.

28. A method according to claim 15 wherein said seismic or acoustic signal is caused by any motorized object.

29. A method according to claim 15 wherein said seismic or acoustic signal is periodic.

30. A computerized method for detecting a seismic or acoustic signal, comprising:
receiving a digital representation indicative of a time-framed portion of seismic or acoustic signal;
calculating an entropy value H of said digital representation;
repeating said calculating for a succession of time-framed portions of said signal; and
indicating a detection in case a similarity criterion is met with respect to part of said time-framed portions, said similarity criterion is based at least on an entropy reference value and on said entropy values H or derivatives thereof, thereby enabling detecting of said seismic or acoustic signal, if such signal exists.

31-35. (canceled)
